(19) United States
(12) Patent Application Publication
(10) Pub. No.: US 2002/0092704 A1
(43) Pub. Date: Jul. 18, 2002

(54) Ladder anti-climbing device

(76) Inventors: Brian Climo, Lauderhill, FL (US); Jerry S. Adams, Hammond, LA (US)

Correspondence Address: K. Scoot O'Brian, Greensfelder, Hemker & Gale, P.C., Intellectual Property Group, 10 South Broadway, Suite 2000, St. Louis, MO, 63102-1774, US

(21) Appl. No.: 10/025,645

(22) Filed: Dec. 19, 2001

Related U.S. Application Data
(60) Provisional application No. 60/261,952, filed on Jan. 16, 2001.

(51) Int. Cl. E06C 7/18

(52) U.S. Cl. 182/106

(57) ABSTRACT

A device for preventing vertical access to a ladder without having to obstruct the horizontal rungs of the ladder having a frame at least substantially as wide as horizontal rungs of the ladder. The frame is attached to at least one end fitting which has a first proximal end that forms a hinged joint thereon and at least one first distal end for pivotally securing a clamshell member. The clamshell member has an aperture formed in a second proximal end for pivotally engaging a portion of the ladder and further has a second distal end with a flanged portion for pivotably securing a slotted wedge which urges the clamshell member tightly about a portion of the ladder. Interposed between the frame and the end fitting is a standoff for extending the frame outwardly from the ladder. By securing the frame substantially perpendicular to the ladder with the end fitting, the frame prevents vertical access to a portion of the ladder above the installed frame.

### CROSS-REFERENCE TO RELATED APPLICATIONS

This application is based upon Provisional Patent Application, Serial No. 60/261,952, entitled “Ladder Anti-Climbing Device”, filed Jan. 16, 2001, contents of which are incorporated herein by reference in their entirety and continued preservation of which is requested.

### BACKGROUND OF THE INVENTION

1. Field of the Invention

The present invention relates to anti-climbing devices, and more particularly to anti-climbing devices for ladders. More specifically, the present invention relates to ladder anti-climbing devices for use with scaffolds.

2. Prior Art

Scaffolding is commonly used in construction and in structural maintenance industries for permitting workers direct access to the perimeter of a desired structure. Typically, scaffolding comprises a number of scaffolds which define adjacently formed open box structures, referred to as bays or modules, that proceed in both horizontal and vertical directions as required to perform a desired task. In use, scaffolding may be built adjacent a building for ease of access by construction workers along the exterior of the building and may be constructed to reach more than 100 feet above the ground. Occupational Safety & Health Administration (OSHA) regulations provide that while scaffolding is under construction, only professional scaffold builders are authorized to be on the scaffolding.

In addition, OSHA regulations further provide that an employer has an affirmative duty to notify unauthorized personnel of hazards associated with the work environment, including scaffolding. Potential hazards regarding scaffolding may include the construction related to the scaffolding structure itself, heavy loads being lifted by crane over the scaffolding, and initial start-up of the installation under construction, i.e., installation of a boiler. Notification of any of these circumstances is usually conveyed by a red tag positioned at the base of a scaffolding ladder to warn those on the ground that may otherwise attempt to scale the scaffolding. Unfortunately, such notifications are sometimes disregarded by unauthorized personnel with tragic results.

The prior art discloses a variety of devices that are designed to prevent access to ladders. These devices generally disclose some form of elongated member secured to the horizontal rungs of the ladder that prevents a potential climber from gaining a foothold on the ladder rungs. Other prior art devices disclose shields or cages that literally encase an entire section of a ladder, thereby preventing unauthorized access. While successful in application, these prior art devices are expensive to manufacture and difficult to install. Therefore, there appears a need in the art for a relatively small, simple to use and inexpensive anti-climbing device.

### OBJECTS AND SUMMARY OF THE INVENTION

The primary object of the present invention is to provide an anti-climbing device for use with scaffolding.

Another object of the present invention is to provide an anti-climbing device that is relatively small and light.

A further object of the present invention is to provide an anti-climbing device that is easy to install.

An additional object of the present invention is to provide an anti-climbing device that can be quickly installed, removed and reinstalled.

Yet another object of the present invention is to provide an anti-climbing device that is inexpensive to manufacture.

These and other objects of the present invention are realized in the preferred embodiment of the present invention, described by way of example and not by way of limitation, which provides for a novel anti-climbing device.

In brief summary, the present invention overcomes and substantially alleviates the deficiencies in the prior art by providing a device for preventing vertical access to a ladder having a plurality of horizontal rungs without having to obstruct the rungs of the ladder. The device comprises a body at least substantially as wide as the horizontal rungs of the ladder with the body having at least one end fitting for securing the body to the ladder such that access thereto is prevented.

Additional objects, advantages and novel features of the invention will be set forth in the description which follows, and will become apparent to those skilled in the art upon examination of the following more detailed description and drawings in which like elements of the invention are similarly numbered throughout.

### BRIEF DESCRIPTION OF THE DRAWINGS

FIG. 1 is a perspective view of a ladder anti-climbing device according to the present invention;

FIG. 2 is a perspective view of the ladder anti-climbing device in its installed position according to the present invention.

FIG. 3 is a perspective view of an end fitting showing an intermediate step of installation onto a scaffold member according to the present invention; and

FIG. 4 is a perspective view of the end fitting being moved into a closing position around the scaffold member according to the present invention.

### DETAILED DESCRIPTION OF THE INVENTION

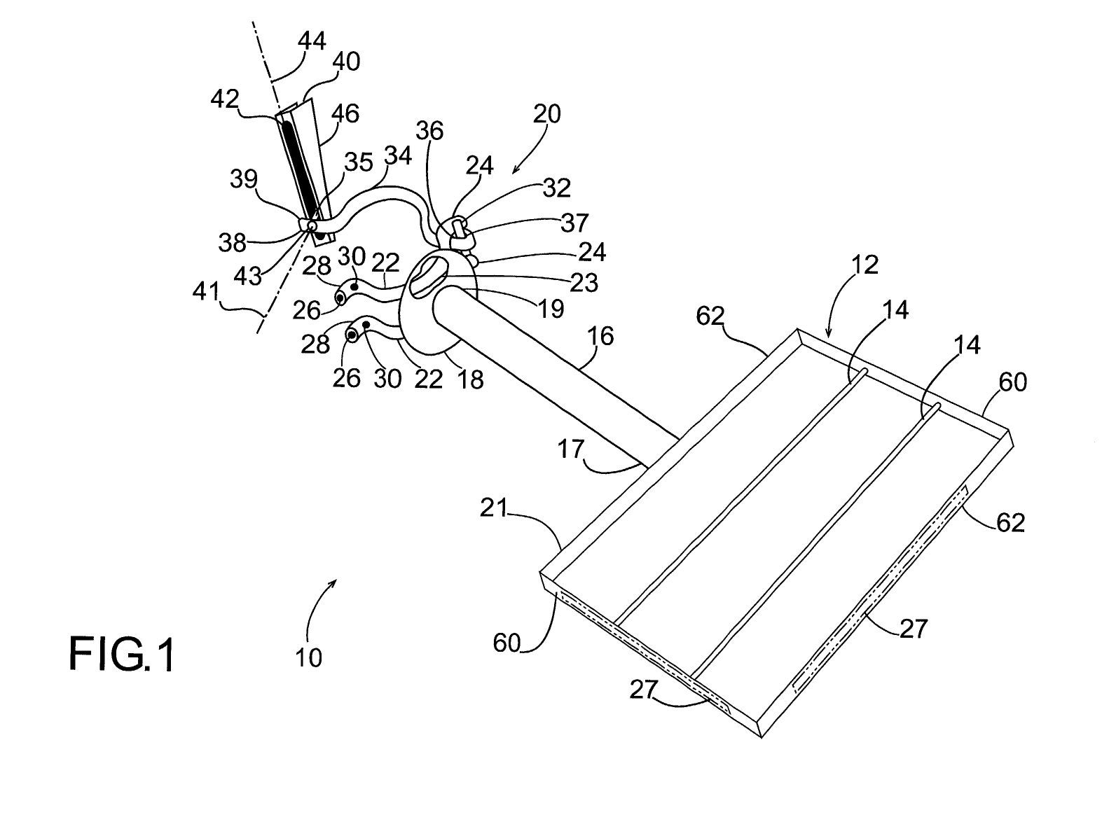

Referring to the drawings, the preferred embodiment of the ladder anti-climbing device of the present invention is illustrated and generally indicated as 10 in FIG. 1. Anti-climbing device 10 comprises a tubular standoff 16 having a distal end 19 attached to a plate 18 and a proximal end 17 attached to a rectangular frame 12 that obstructs a person's ability to scale a ladder. As further shown, plate 18 attaches to an end fitting 20 for securing device 10 to a ladder.

Frame 12 comprises a rectangular-shaped member 21 bounded by opposing short portions 60 and opposing long portions 62 with stiffening members 14 extending between short portions 60 for providing rigidity to member 21 while minimizing the overall weight of the anti-climbing device 10. Additionally, proximal end 17 is securely attached to the mid-span to one of the long portions 62 so that standoff 16 is attached coplanar with frame 12. Preferably, frame 12 can be painted a conspicuous color, such as red, so that it is noticed and heeded by unauthorized persons. Moreover, warning signage 27 such as “DANGER—DO NOT CLIMB” and “NO STEP” may be affixed to the periphery of member 21.

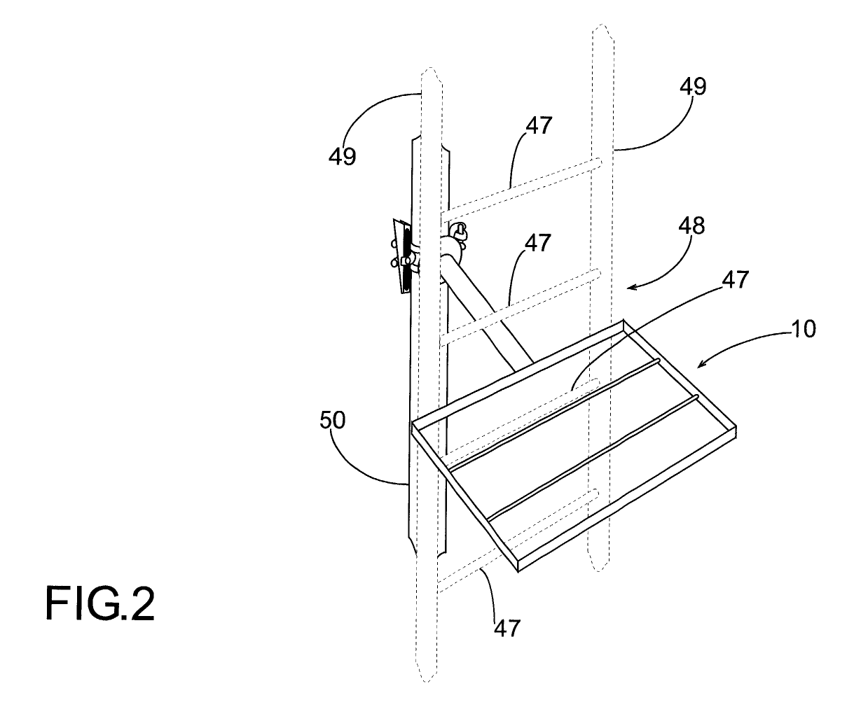

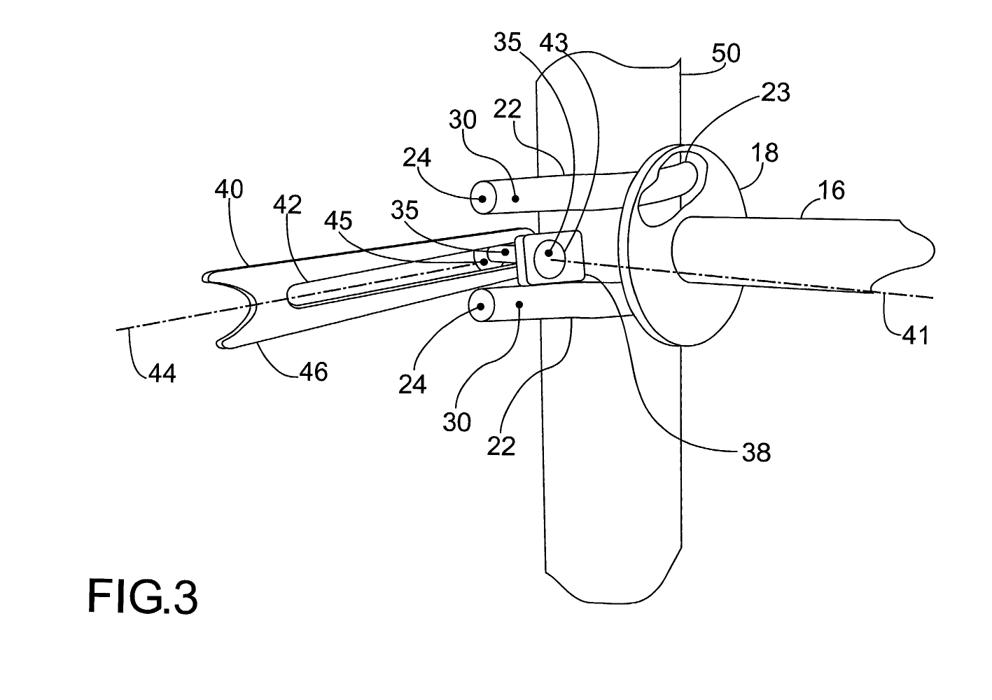

Referring to FIGS. 1 and 2, plate 18 attaches to end fitting 20 which comprises a yoke-shaped clamshell member 34 with a wedge 40 connected at its free end by a pin 35 while a hinged joint 32 with two yoke-shaped fingers 22 secures the other end of clamshell member 34 to plate 18. Clamshell member 34 provides the means for securing end fitting 20 to scaffold member 50. As further shown, clamshell member 34 includes a second proximal end 37 having an aperture 36 which pivotally engages hinged joint 32 and a distal end 39 having a flanged portion 38. An aperture 43 is formed through flanged portion 38 for securing pin 35 which extends from flanged portion 38 along axis 41 and terminates in an enlarged head 45 (FIG. 3) for pivotally securing wedge 40 to clamshell member 34. Preferably, end fitting 20 is a wedge clamp manufactured by Thiel Manufacturing & Supply Company in Webster, Tex.

Referring to FIG. 1, fingers 22 include first proximal ends 24 defining a hinged joint 32 for pivotally engaging aperture 36 of clamshell member 34. Moreover, fingers 22 include midspan portions 23 which attach to plate 18 to secure end fitting 20 thereto. Fingers 22 additionally include first distal ends 26 having scaffold-facing surfaces 28 and device-facing surfaces 30 for interacting with wedge 40 as shall be discussed in greater detail below.

Referring to FIGS. 1 and 3, wedge 40 includes an enlarged portion 46 and an elongated slot 42 which is directed along longitudinal axis 44 for pivotally engaging pin 35. When securing end fitting 20 to scaffold member 50, wedge 40 is caused to be pivotally captured along pin 35 between flanged portion 38 and enlarged head 45.

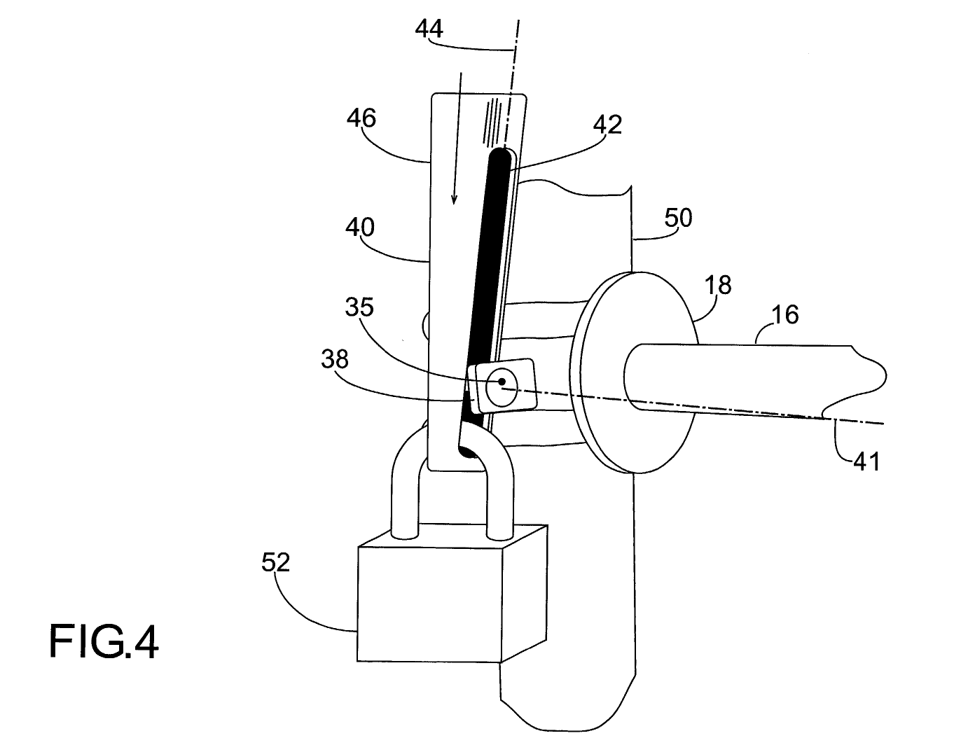

Referring to FIGS. 2-4, the operation of anti-climbing device 10 shall now be discussed. To engage anti-climbing device 10 with ladder 48 the user first directs end fitting 20 between horizontal ladder rungs 47 and vertical side members 49 of ladder 48 toward scaffold member 50 at a height of approximately 6½ to 7 feet above the ground so that frame 12 extends outwardly and is oriented at a substantially perpendicular angle relative to ladder 48, thereby preventing access to those horizontal ladder rungs 47 above frame 12 by creating a physical barrier to further vertical movement by a person. As shown in FIG. 2, midspan portion 23 of fingers 22 are placed into fitting contact with scaffold member 50. Referring to FIG. 3, enlarged end 46 is then directed along longitudinal axis 44 in a direction away from pin 35 until slot 42 “bottoms out” against pin 35. Wedge 40 is then rotated about axis 41 until it is generally perpendicular, or horizontal, to scaffold member 50. After wedge 40 is rotated, clamshell member 34 and the horizontally positioned wedge 40 are rotated about hinged joint 32 until wedge 40 and flanged portion 38 pass between and through first proximal ends 24 of fingers 22. At this point, clamshell member 34 and fingers 22 have securely captured scaffold member 50. Referring to FIG. 4, by rotating wedge 40 approximately 90 degrees about axis 41 and then directing enlarged portion 46 of wedge 40 along slotted longitudinal axis 44 toward pin 35, flanged portion 38 of clamshell member 34 becomes biased in a direction away from fingers 22. In other words, wedge 40 becomes interposed between device-facing surface 30 of fingers 22 and enlarged portion 38 of clamshell member 34. It should be appreciated that moving wedge 40 in this direction acts to tighten clamshell member 34 about scaffold member 50. Finally, after clamshell member 34 has been sufficiently tightened about scaffold member 50, at least one locking device 52 may be inserted through slot 42 to ensure device 10 remains in its installed position.

One skilled in the art can appreciate that frame 12, although represented as a closed geometric shape, preferably a rectangle, could have any number of other shapes without departing from the spirit and scope of the present invention. Additionally, stiffening members 14 which are included to add rigidity to frame 12 while minimizing weight could likewise extend in any number of directions. Further, frame 12 may be substantially shorter than it is wide or long which may greatly reduce its size and weight without adversely affecting its intended operation of blocking direct access to the horizontal rungs of the ladder above frame 12. It should also be appreciated that end fitting 20 may engage any underlying supporting structure which may be required to secure device 10 to a ladder. Alternatively, device 10 may have more than one standoff 16 with each standoff 16 having at least one end fitting to permit securement of device 10 to ladder rungs 47 and/or side members 49. Additionally, it should be appreciated that standoff 16 may be of adjustable length so that frame 12 may be secured in a position which prevents vertical access to a ladder irrespective of whether end fitting 20 engages any combination of ladder rungs 47, ladder side members 49, or underlying structure. Moreover, the present invention contemplates that only the frame 12 alone attached to end fitting 20 may be sufficient to prevent vertical access to the ladder.

Preferably, anti-climbing device 10 is constructed of a conspicuous color, such as red, although other colors may be desirable. Finally, end fittings 20 may be utilized to accommodate any variety of profiles, i.e., sizes and shapes, of scaffold members 50, ladder rungs 47 or side members 49.

It should be understood from the foregoing that, while particular embodiments of the invention have been illustrated and described, various modifications can be made thereto without departing from the spirit and scope of the present invention. Therefore, it is not intended that the invention be limited by the specification; instead, the scope of the present invention is intended to be limited only by the appended claims.

What is claimed is:

1. A device for preventing vertical access to a ladder having a plurality of horizontal rungs comprising:
a frame, said frame is attached to at least one end fitting for securing said frame in a manner substantially perpendicular to the ladder such that vertical access to a portion of the ladder above said frame is prevented.

2. The device according to claim 1, wherein said frame is at least substantially as wide as the horizontal rungs of the ladder.

3. The device according to claim 1, wherein said frame has opposed long and short portions.

4. The device according to claim 1, wherein said frame is shorter than it is wide.

5. The device according to claim 1, wherein said frame defines a closed geometric shape.

6. The device according to claim 1, wherein said frame defines a rectangular frame.

7. The device according to claim 1, wherein at least one locking device can be secured to the device.

8. The device according to claim 1, wherein said at least one end fitting can be adjustably secured to a structure having a range of dimensions and shapes.

9. The device according to claim 1, wherein said at least one end fitting is a wedge clamp.

10. The device according to claim 1, wherein said device displays warning signage along said frame.

11. The device according to claim 1, wherein the device further comprises a standoff interposed between said at least one end fitting and said frame for extending said frame outwardly from the ladder.

12. The device according to claim 1, wherein said at least one end fitting having a first proximal end forming a hinged joint thereon and at least one first distal end, said hinged joint pivotally securing a clamshell member having an aperture formed in a second proximal end for pivotally engaging the ladder, said clamshell member further having a second distal end with a flanged portion, said flanged portion pivotally securing a wedge having a slot formed along a longitudinal axis.

13. The device according to claim 3, wherein said opposed long and short portions have at least one stiffening member extending therebetween.

14. The device according to claim 12, wherein said wedge has an enlarged end thereon.

15. A device for preventing vertical access to a ladder having a plurality of horizontal rungs comprising:
a frame, said frame is attached to at least one end fitting, said at least one end fitting having a first proximal end forming a hinged joint thereon and at least one first distal end, said hinged joint pivotally securing a clamshell member having an aperture formed in a second proximal end for pivotally engaging the ladder supporting structure, said clamshell member further having a second distal end with a flanged portion, said flanged portion pivotally securing a wedge having a slot formed along a longitudinal axis, said end fitting securing said frame substantially perpendicular to the ladder such that vertical access to a portion of the ladder above said frame is prevented.

16. The device according to claim 15, wherein at least one locking device can be secured to said device.

17. The device according to claim 15, further comprising a standoff interposed between said at least one end fitting and said frame.

18. The device according to claim 17, wherein said standoff extends said frame outwardly from the ladder.

19. A device for preventing vertical access to a ladder having a plurality of horizontal rungs, the ladder being secured by a supporting structure, comprising:
a frame at least substantially as wide as the horizontal rungs of the ladder, said frame having at least one end fitting for securing to the supporting structure so that said frame extends outwardly and is oriented substantially perpendicular to the ladder such that vertical access to a portion of the ladder above said frame is prevented.

20. The device according to claim 19, wherein the device further comprises a standoff having a predetermined length interposed between said frame and said at least one end fitting for positioning said frame such that access to the ladder is prevented.

21. The device according to claim 20, wherein said standoff having opposing ends is of a tubular construction.

22. The device according to claim 20, wherein the device further comprises a plate interposed between said at least one end fitting and said standoff.

23. The device according to claim 20, wherein said predetermined length of said standoff is adjustable.

24. The device according to claim 20, wherein said standoff extends said frame outwardly from the ladder.

25. A method for preventing vertical access to a ladder having a plurality of horizontal rungs, the ladder secured to a support structure, the steps of the method comprising:
a) providing a frame, said frame is attached to at least one end fitting, said at least one end fitting having a first proximal end forming a hinged joint thereon and at least one first distal end, said hinged joint being pivotally secured to a clamshell member having an aperture formed in a second proximal end for pivotally engaging the support structure, said clamshell member further having a second distal end with a flanged portion, said flanged portion pivotably securing a wedge having a slot formed along a longitudinal axis and an enlarged end thereon, said at least one end fitting for securing said frame substantially perpendicular to the ladder such that vertical access to a portion of the ladder above the installed frame is prevented;
b) directing said end fitting between adjacent horizontal rungs of the ladder until engaging the support structure;
c) positioning said frame such that said frame is substantially perpendicular to the ladder;
d) pivoting said second distal end of said clamshell member about the support structure thereby securely capturing said support structure therein; and
e) interposing said slotted wedge between said at least one first proximal end and said flanged portion so that directing said enlarged end along said longitudinal axis of said slot between said at least one first proximal end and said flanged portion urges said clamshell member more tightly about the support structure.

26. A method for preventing vertical access to a ladder having a plurality of horizontal rungs and at least one vertical member, the steps of the method comprising:
a) providing a frame, said frame is attached to at least one end fitting, said at least one end fitting having a first proximal end forming a hinged joint thereon and at least one first distal end, said hinged joint pivotally securing a clamshell member having an aperture formed in a second proximal end for pivotally engaging a portion of the ladder, said clamshell member further having a second distal end with a flanged portion, said flanged portion pivotably securing a wedge having a slot formed along a longitudinal axis and an enlarged end thereon, said end fitting for securing said frame substantially perpendicular to the ladder such that vertical access to a portion of the ladder above the installed frame is prevented;
b) directing said at least one end fitting until engaging at least one horizontal rung or vertical side of the ladder;
c) positioning said frame such that said frame is substantially perpendicular to the ladder;
d) pivoting said second distal end of said clamshell member about at least one horizontal rung or vertical member thereby securely capturing said at least one horizontal rung or vertical member therein; and
e) interposing said slotted wedge between said at least one first proximal end and said flanged portion so that directing said enlarged end along said longitudinal axis of said slot between said at least one first proximal end and said flanged portion urges said clamshell member more tightly about said at least one horizontal rung or vertical member.
